(19) United States
(12) Patent Application Publication
(10) Pub. No.: US 2026/0044109 A1
(43) Pub. Date: Feb. 12, 2026

(54) STRUCTURE FOR RELEASING HEAT GENERATED INSIDE OF IMAGE FORMING APPARATUS

(71) Applicant: CANON KABUSHIKI KAISHA, Tokyo (JP)

(72) Inventor: MASAO UMEZAWA, Shizuoka (JP)

(21) Appl. No.: 19/285,968

(22) Filed: Jul. 30, 2025

(30) Foreign Application Priority Data
Aug. 6, 2024 (JP) 2024-130008

(51) Int. Cl. G03G 21/20; G03G 15/20; G03G 21/16

(52) U.S. Cl. CPC G03G 21/206; G03G 15/2017; G03G 21/1633; G03G 21/1647; G03G 2221/1645; G03G 2221/1684

(57) ABSTRACT

A coupling unit couples a main body unit and a reader unit and supports the reader unit. The coupling unit includes a top surface that supports the reader unit, a bottom surface supported by the main body unit, a first wall that extends from the bottom surface toward the top surface; a second wall that extends from the bottom surface toward the top surface, and a first opening provided on the bottom surface and that connects an internal space between the first wall and the second wall, and the main body unit. The first wall includes a first air duct opening that connects the internal space and an external space. The second wall includes a second air duct opening that connects the internal space and an external space.

### BACKGROUND

### Field of the Technology

The present disclosure relates to a structure that releases heat generated inside of an image forming apparatus.

### Description of the Related Art

Image forming apparatuses fix a toner image on a sheet using a fixing device, which is a heat source. Japanese Patent Laid-Open No. 2012-255868 proposed that an air duct be formed in the vicinity of a fixing device, and that heat be discharged from the inside of the image forming apparatus to the outside through the air duct. Japanese Patent Laid-Open No. 2007-065105 proposes providing, in an image forming apparatus including an image reading apparatus, fans that forcibly discharge heat accumulated in a gap between a main body of the image forming apparatus and the image reading apparatus.

Japanese Patent Laid-Open No. 2007-065105 discusses providing an exhaust unit between an image forming unit and a reader unit formed on an upper portion thereof or in the reader unit, and also providing fans within the exhaust unit. In order to provide the fan, space for providing the fan is required. When space limitation is severe, only small fans with low wind power can be attached to the exhaust unit, and it becomes difficult to sufficiently dissipate heat of the image forming apparatus. In particular, the exhaust unit of Japanese Patent Laid-Open No. 2007-065105 comprises only a single exhaust opening, and has poor heat dissipation performance.

### SUMMARY

There is a need to improve heat dissipation efficiency without installation of a fan or the like in a coupling unit for coupling an image forming unit and a reader unit in order to turn the coupling unit into an exhaust unit. The present disclosure provides an image forming apparatus that includes a main body unit having an image forming unit configured to form an image on a recording medium; a reader unit disposed above the main body unit and configured to read a document; a stacker unit disposed between the main body unit and the reader unit, wherein the recording medium, on which an image has been formed by the main body unit, is stacked on the stacker unit; and a coupling unit configured to couple the main body unit and the reader unit, and support the reader unit. The coupling unit comprises a top surface that supports the reader unit, a bottom surface supported by the main body unit, a first wall that extends from the bottom surface toward the top surface, a second wall that extends from the bottom surface toward the top surface, and a first opening provided on the bottom surface and that connects an internal space between the first wall and the second wall, and the main body unit. The first wall comprises a first air duct opening that connects the internal space and an external space. The second wall comprises a second air duct opening that connects the internal space and the external space.

Features of the present disclosure will become apparent from the following description of embodiments with reference to the drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic cross-sectional view of an image forming apparatus according to a first embodiment.

FIG. 2 is a front perspective view illustrating a method for removing a processing cartridge.

FIG. 3 is a front perspective view illustrating a state in which a cartridge cover has been opened.

FIG. 4 is a front perspective view illustrating a method for removing a toner cartridge.

FIG. 5 is a perspective view of internal components of the image forming apparatus.

FIG. 6 is a front surface view of the image forming apparatus.

FIG. 7 is a back view of the image forming apparatus according to the first embodiment.

FIG. 8 is a back perspective view of the image forming apparatus according to the first embodiment.

FIG. 9 is a perspective view of internal components of the image forming apparatus.

FIG. 10 is a back perspective view showing a first modification.

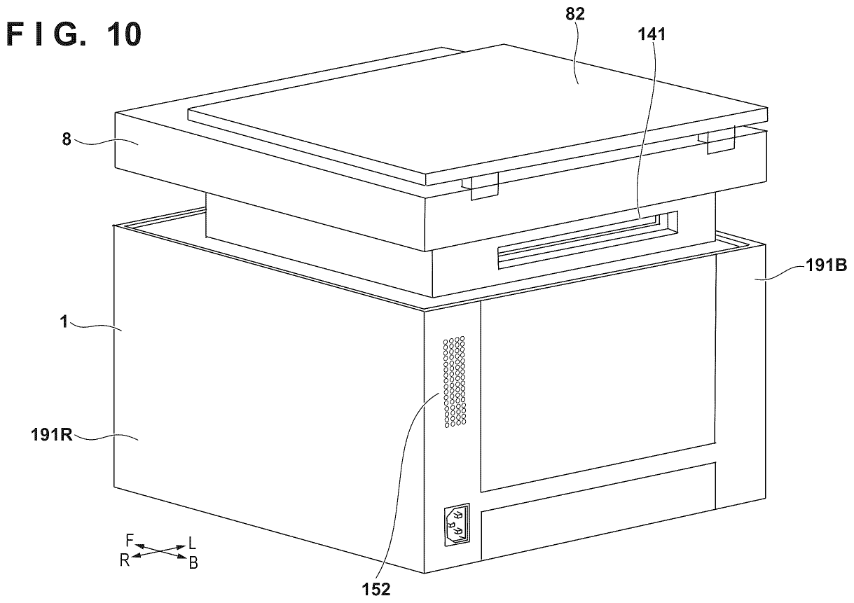

FIG. 11 is a back perspective view showing a second modification.

FIG. 12 is a schematic cross-sectional view of an image forming apparatus in a second embodiment.

FIG. 13 is a back perspective view of the image forming apparatus in the second embodiment.

FIG. 14 is a schematic cross-sectional view of an image forming apparatus in a third embodiment.

FIG. 15 is a back perspective view of the image forming apparatus according to the third embodiment.

### DESCRIPTION OF THE EMBODIMENTS

Hereinafter, embodiments will be described in detail with reference to the drawings. Note, the following embodiments are not intended to limit the scope of the claims. Multiple features are described in the embodiments, but it is not the case that all such features are required, and multiple such features may be combined as appropriate. In the drawings, the same reference numerals are given to the same or similar configurations, and redundant description thereof is incorporated by reference, for conciseness.

### First Embodiment

### 1. Structure of Image Forming Apparatus

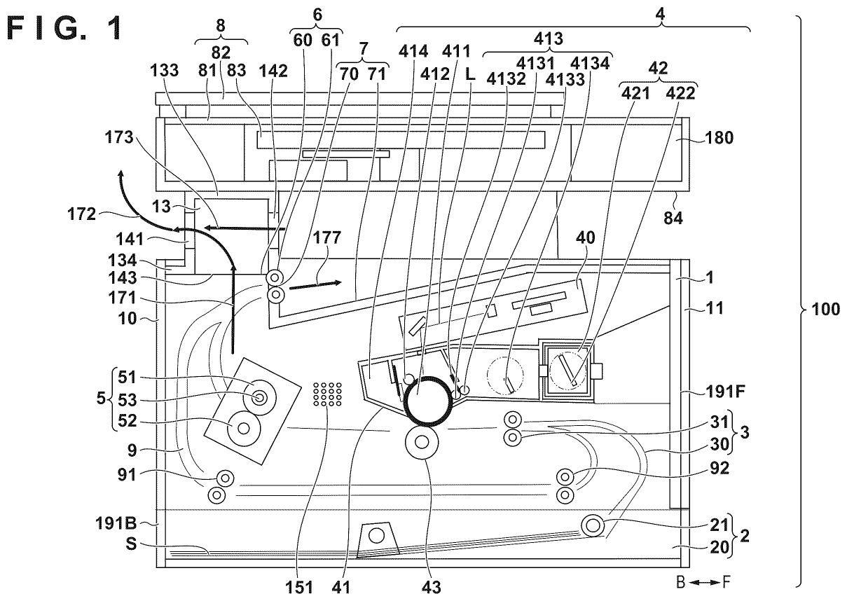

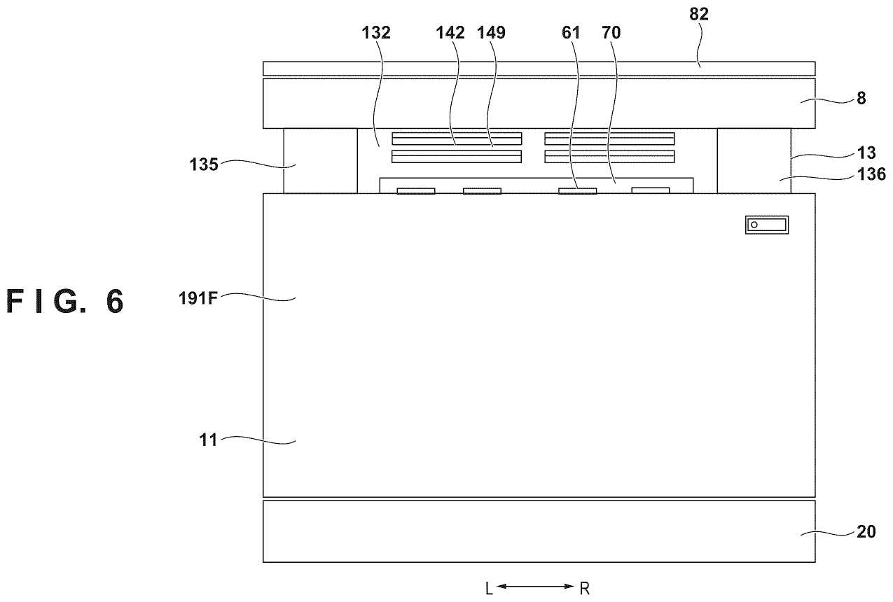

As shown in FIG. 1, an image forming apparatus 100 is an electrophotographic copying machine, with a direction extending from a bottom to a top of the image forming apparatus 100 along the plane of the drawing being referred to as the upward direction. A direction opposite the upward direction is referred to as the downward direction. A direction extending from a right side to a left side of FIG. 1 is referred to as the back direction (extending toward back side 191B of the image forming apparatus 100). A direction extending from a left side to a right side in FIG. 1 of the image forming apparatus 100 is referred to as the front direction (extending toward front side 191F) of the image forming apparatus 100). A direction extending from a right side to a left side of FIG. 6 is referred to as the leftward direction (extending toward left side 191L of the image forming apparatus 100). A direction extending from the left side to the right side of FIG. 6 is referred to as the rightward direction (extending toward right side 191R of the image forming apparatus 100). In the drawings, front, back, left and rear are labelled F, B, L, and R, corresponding to front, back, left and right, respectively, are depicted with respective arrows.

As illustrated in FIG. 1, the image forming apparatus 100 is constituted by a main body unit 1, a feeding unit 2, a main conveyance unit 3, an image forming unit 4, a fixing unit 5, a discharge unit 6, a stacker unit 7, a reader unit 8, and a sub-conveyance unit 9. The main body unit 1 includes a mechanism for forming an image on a recording medium S. The feeding unit 2 is disposed in a lower portion in the main body unit 1, and feeds the recording medium S. The main conveyance unit 3 is disposed in front of the main body unit 1, and conveys the recording medium S from the feeding unit 2 to the image forming unit 4. The image forming unit 4 is disposed in the center of the main body unit 1, and forms an image on the recording medium S with toner. The fixing unit 5 and the discharge unit 6 are disposed toward the rear within the main body unit 1. The fixing unit 5 is a mechanism that fixes a toner image on the recording medium S. The discharge unit 6 discharges the recording medium S from the inside to the outside of the main body unit 1. Arrow 177 indicates a direction in which the recording medium S is discharged. The stacker unit 7 is disposed in an upper portion in the main body unit 1, and holds the recording medium S. The reader unit 8 is disposed above the main body unit 1 and the stacker unit 7.

### 2. Feeding Unit and Conveyance Unit

The feeding unit 2 includes a cassette 20 and a pickup roller 21. The cassette 20 is a storage compartment for storing a plurality of recording mediums S. The pickup roller 21 picks up one recording medium S out of a plurality of recording mediums S stacked and stored in the cassette 20, and feeds the recording medium S to the main conveyance unit 3.

The main conveyance unit 3 includes a conveyance guide 30 and a conveyance roller pair 31. The conveyance guide 30 is a guide for regulating a movement trajectory of the recording medium S. The conveyance roller pair 31 is a roller pair that conveys the recording medium S to the image forming unit 4. Further, the conveyance roller pair 31 performs alignment between the toner image and the recording medium S.

### 3. Image Forming Unit

The image forming unit 4 includes a laser scanner unit 40, a processing cartridge 41, a toner cartridge 42, and a transfer roller 43. The laser scanner unit 40 includes an exposure light source that irradiates a photosensitive drum 411 with laser light to form a latent image. The processing cartridge 41 includes the photosensitive drum 411, a charging member 412, a developing unit 413, and a cleaning member 414. The processing cartridge 41 and the toner cartridge 42 may be collectively referred to as a processing unit. The photosensitive drum 411 is an image carrier that rotates while carrying an electrostatic latent image and while carrying a toner image. The charging member 412 is a charging wire or a charging roller that charges the surface (image forming surface) of the photosensitive drum 411. The developing unit 413 develops an electrostatic latent image on the photosensitive drum 411 using toner to generate a toner image. The cleaning member 414 is a cleaning unit (e.g., a blade-shaped resin plate or a resin brush) that cleans a residue (e.g., toner) remaining on the photosensitive drum 411.

The developing unit 413 includes a developing roller 4131, a developing blade 4132, a supply roller 4133, and a stirring member 4134. The stirring member 4134 stirs the toner supplied from the toner cartridge 42 to the developing unit 413. The supply roller 4133 supplies toner stored in the developing unit 413 to the developing roller 4131. The developing blade 4132 is a regulation member that regulates the layer thickness of the toner adhering to the surface of the developing roller 4131. The developing roller 4131 is a toner carrying unit that rotates while carrying toner. The toner carried on the developing roller 4131 adheres to the photosensitive drum 411, thereby generating a toner image.

The toner cartridge 42 includes a toner storage unit 421 and a conveyance paddle 422. The toner storage unit 421 is a toner storage container that stores toner. The conveyance paddle 422 is a conveyance member that conveys toner stored in the toner storage unit 421 to the developing unit 413.

The transfer roller 43 is a transfer member that transfers a toner image carried on the photosensitive drum 411 to the recording medium S. The transfer roller 43 may be replaced by a member in another form such as a transfer brush or a transfer blade. An abutting portion formed between the transfer roller 43 and the photosensitive drum 411 may be referred to as a transfer nip.

### 4. Fixing Unit

The fixing unit 5 includes a heating roller 51, a pressure roller 52, and a heating member 53. The heating roller 51 is disposed so as to face and abut against the pressure roller 52. The heating member 53 is installed on the inner peripheral side of the heating roller 51. The heating member 53 heats the heating roller 51. The heating member 53 is, for example, a halogen heater or a ceramic heater. The heating roller 51 may be a cylindrical endless film having a space therewithin. The pressure roller 52 is a rotating body that presses the recording medium S and the toner image against the heating roller 51. The recording medium S and the toner image pass through a nip portion formed by the abutment between the heating roller 51 and the pressure roller 52. As a result, the toner image is heated and pressurized, and is fixed on the recording medium S.

### 5. Discharge Unit and Stacker Unit

The discharge unit 6 includes a conveyance guide 60 and a discharge roller pair 61. The stacker unit 7 includes a discharge opening 70 and a stacking tray 71. The conveyance guide 60 is a guidance member that is from the fixing unit 5 to the discharge opening 70 and guides the recording medium S. The discharge roller pair 61 is a rotating body that discharges the recording medium S after it has been conveyed along the conveyance guide 60 to the stacker unit 7. The discharge opening 70 is provided in a part of a housing 10, and is an opening for discharging, to the outside of the main body unit 1, a recording medium S on which a toner image has been fixed. The stacking tray 71 is a stacking member (for example, a support plate) on which recording mediums S on which a toner image has been fixed are stacked.

### 6. Document Reader

The reader unit 8 includes a platen glass 81, a pressing plate 82, and an image sensor 83. The platen glass 81 is a light-transmitting flat plate on which a document is placed. The pressing plate 82 presses the document against the platen glass 81. The image sensor 83 reads a document that has been placed on the platen glass 81 and generates an image signal. The image forming unit 4 generates a toner image based on the image signal.

### 7. Sub-Conveyance Unit

The image forming apparatus 100 has a single-sided printing mode in which an image is formed on one side of the recording medium S and a double-sided printing mode in which an image is formed on both sides of the recording medium S. When the double-sided printing mode is selected by the user, the sub-conveyance unit 9 is used. When a recording medium S on a first surface of which an image has been formed reaches the discharge unit 6, the discharge roller pair 61 stops while holding the recording medium S. Next, by the discharge roller pair 61 starting reverse rotation, the recording medium S is fed to the sub-conveyance unit 9. When a conveyance roller pair 91 and a conveyance roller pair 92 provided in the sub-conveyance unit 9 convey the recording medium S, the recording medium S is conveyed to the image forming unit 4 again. When the recording medium S is conveyed through the sub-conveyance unit 9, the second surface of the recording medium S faces the photosensitive drum 411. The image forming unit 4 forms a toner image on the second surface, and the fixing unit 5 fixes the toner image onto the second surface. The discharge unit 6 discharges the recording medium S on which double-sided printing has been completed to the stacker unit 7.

### 8. Processing Cartridge and Toner Cartridge

The toner cartridge 42 is configured to be attachable to and detachable from the processing cartridge 41. When the amount of toner stored in the toner storage unit 421 becomes small, the used toner cartridge 42 is separated from the processing cartridge 41. A new toner cartridge 42 is attached to the processing cartridge 41.

By repeatedly performing the image forming operation, each component of the processing cartridge 41 including the photosensitive drum 411 gradually degrades. In the first embodiment, the processing cartridge 41 is configured to be detachable from the main body unit 1. A degraded processing cartridge 41 is replaced with a new processing cartridge 41.

### 9. Reader Unit Support Structure

A coupling unit 13 is a structure that couples the image forming unit 4 and the reader unit 8, and supports a bottom surface 84 of the reader unit 8 on a top surface 133 of the coupling unit 13. The coupling unit 13 is disposed above the fixing unit 5, and comprises the top surface 133 that supports the reader unit 8. A bottom surface 134 of the coupling unit 13 is supported by the main body unit 1. The internal space of the coupling unit 13 connects with the internal space of the main body unit 1 via an opening 143. The coupling unit 13 comprises a plurality of side walls. Among the plurality of side walls, an air duct opening 141 is provided in a side wall provided on the back side B of the image forming apparatus 100. Among the plurality of side walls, an air duct opening 142 is provided in a side wall provided on the front side A of the image forming apparatus 100. The air duct opening 141 connects the internal space of the coupling unit 13 with a space (stacking space) for holding recording mediums S provided between the main body unit 1 and the reader unit 8.

As indicated by arrows 171 and 172, air heated by the heat generated in the fixing unit 5 rises from the main body unit 1 toward the coupling unit 13, and is discharged from the air duct opening 141. As indicated by arrows 173 and 172, the air heated by recording mediums S stacked on the stacker unit 7 enters the internal space of the coupling unit 13 through the air duct opening 142, and is discharged to an external space of the coupling unit 13 through the air duct opening 141.

By employing such a coupling unit 13, it is possible to efficiently discharge the heat generated by the fixing unit 5 to the outside without installing a fan in the coupling unit 13. It becomes possible to not provide any fan in the coupling unit 13, or to miniaturize a fan previously existing in the coupling unit 13. Therefore, it is possible to reduce the size of the coupling unit 13. By reducing the size of the coupling unit 13, the height of the coupling unit 13 may be reduced. As a result, even though the air duct openings 141 and 142 are provided in the coupling unit 13, the coupling unit 13 can maintain sufficient rigidity.

Moisture contained in the recording medium S, when heated, becomes water vapor. This water vapor tends to become trapped in the stacking space between the main body unit 1 and the reader unit 8. This is because the back side, the right side and the left side of the stacking space are shielded by the coupling unit 13, and only the front side is open to the outside of the image forming apparatus 100. By virtue of the first embodiment, air (hot air, water vapor) that may have become trapped between the main body unit 1 and the reader unit 8 is also efficiently discharged to the outside of the image forming apparatus 100 through the coupling unit 13. That is, the water vapor released from the recording medium S or the discharge unit 6 into the stacking space enters the coupling unit 13 through the air duct opening 142, and is discharged from the air duct opening 141 to the outside of the coupling unit 13. As a result, condensation caused by the water vapor is suppressed. Failures of the electrical device, such as short-circuiting of the electrical circuit caused by water droplets due to condensation, may also be reduced. Mechanical problems, such as rusting of metals, may also be reduced. Deterioration in image quality due to adhesion of water droplets to the recording medium S will also likely be prevented.

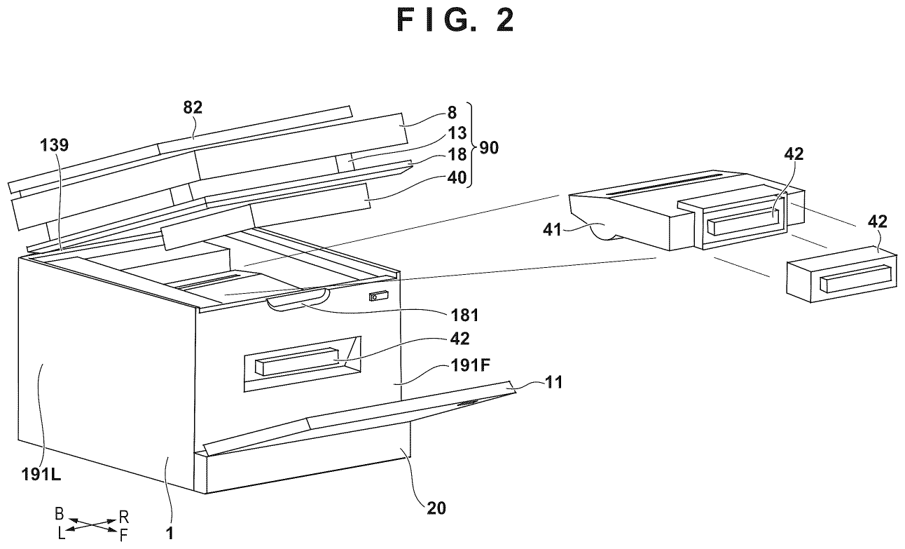

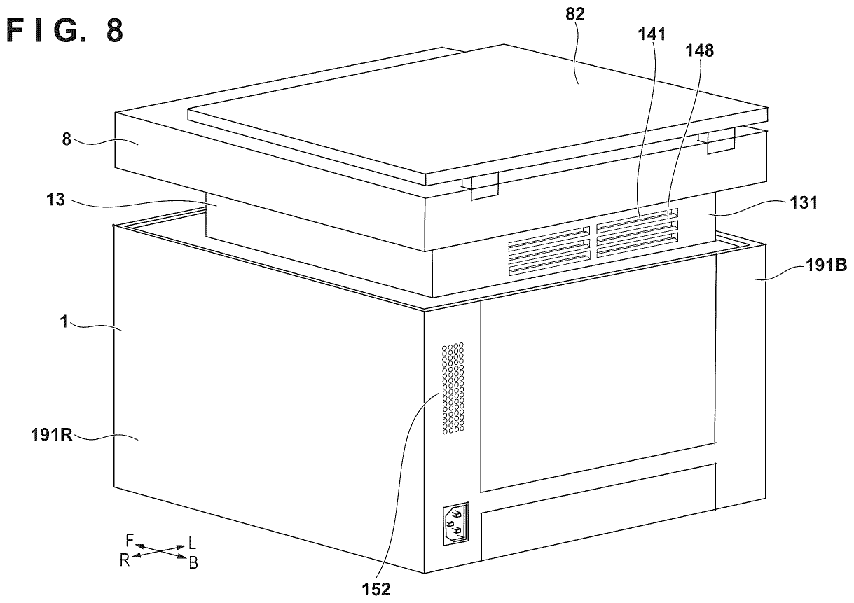

As shown in FIG. 1, the housing 10 of the main body unit 1 comprises the front side 191F and the back side 191B. Also, the housing 10 also comprises the left side 191L (FIG. 2) and the right side 191R (FIG. 8). An air duct opening 151 may be provided in at least one of the left side 191L and the right side 191R. The air duct opening 151 connects the inside and the outside of the main body unit 1. As will be described later, a fan that performs intake or exhaust may be attached to the air duct opening 151.

### 10. Attaching and Removing a Cartridge

As shown in FIG. 2, the reader unit 8 is rotatably supported by the main body unit 1 via a hinge 139. In this example, the reader unit 8 is integrated with the coupling unit 13, an upper cover 18, and the laser scanner unit 40 to form a cover unit 90. The hinge 139 can allow the cover unit 90 to rotate with respect to the main body unit 1 so that the cover unit 90 exposes or covers the main body unit 1. As is apparent from FIG. 1, the discharge unit 6 may also be integrated with the cover unit 90. In this manner, the coupling unit 13 may be fixed on the upper cover 18. The laser scanner unit 40 is fixed under the upper cover 18. By moving the upper cover 18 from the closed state to the open state, the user can take out or attach the processing cartridge 41 from the main body unit 1. A finger port 181 may be provided on the front side 191F of the main body unit 1. The user can easily lift up the upper cover 18 by inserting a finger into the finger port 181.

The finger port 181 may be covered with a cartridge cover 11 provided on the front side 191F of the main body unit 1. The cartridge cover 11 can also move between an open state and a closed state. Therefore, in order to open the upper cover 18, it may be necessary to first open the cartridge cover 11.

By removing the processing cartridge 41 from the main body unit 1, the user can easily remove a recording medium S that is jammed inside the main body unit 1.

As shown in FIG. 2, the toner cartridge 42 can be separated from the processing cartridge 41. The toner cartridge 42 can be taken out of the main body unit 1 independently, or the toner cartridge 42 can be attached to the main body unit 1. Thus, the toner cartridge 42 and the processing cartridge 41 are an example of a plurality of separatable assemblies. Here, “assembly”means an aggregate of a plurality of parts.

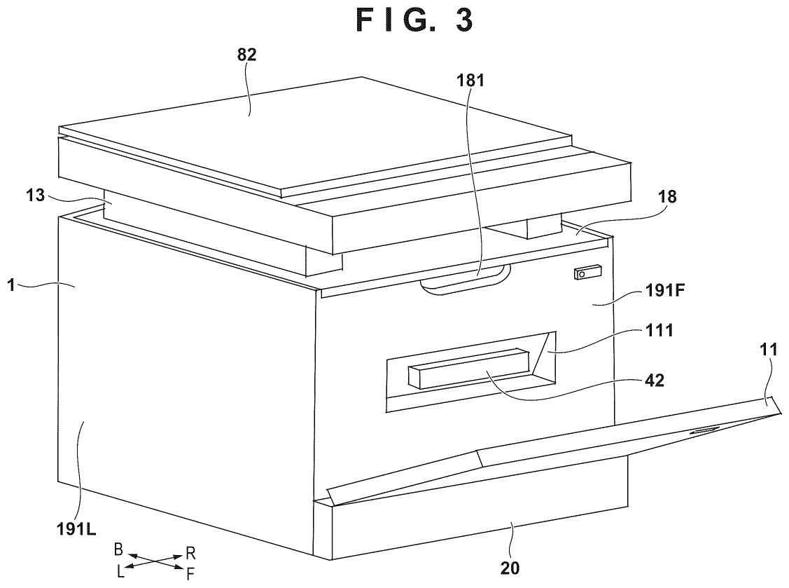

As shown in FIG. 3, a detachable opening 111 may be provided on the front side 191F of the main body unit 1. When the cartridge cover 11 is opened, the user can visually recognize the toner cartridge 42 through the detachable opening 111 and can access the toner cartridge 42.

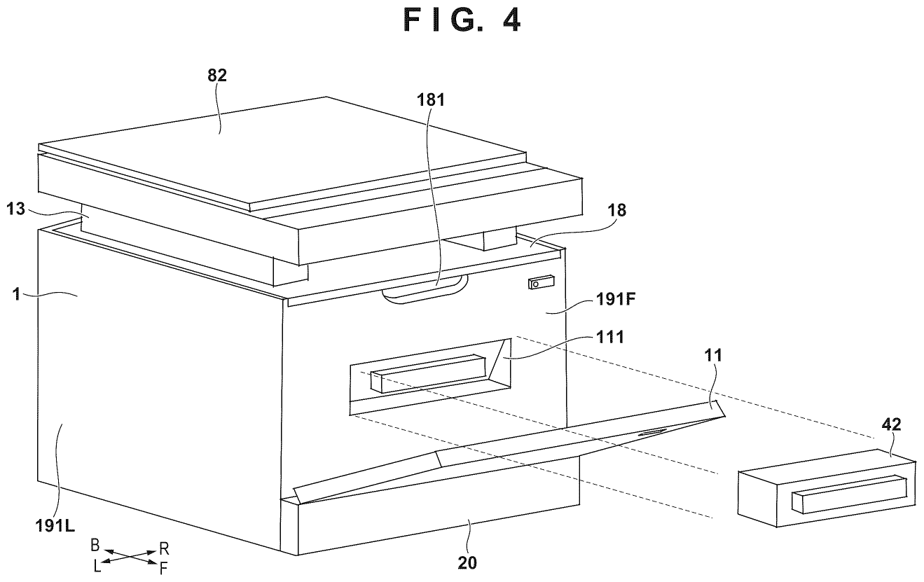

As shown in FIG. 4, the user can take out the toner cartridge 42 through the detachable opening 111 even when the upper cover 18 is kept closed. This improves the operability in attaching and detaching the toner cartridge 42.

### 11. Exhaust Unit

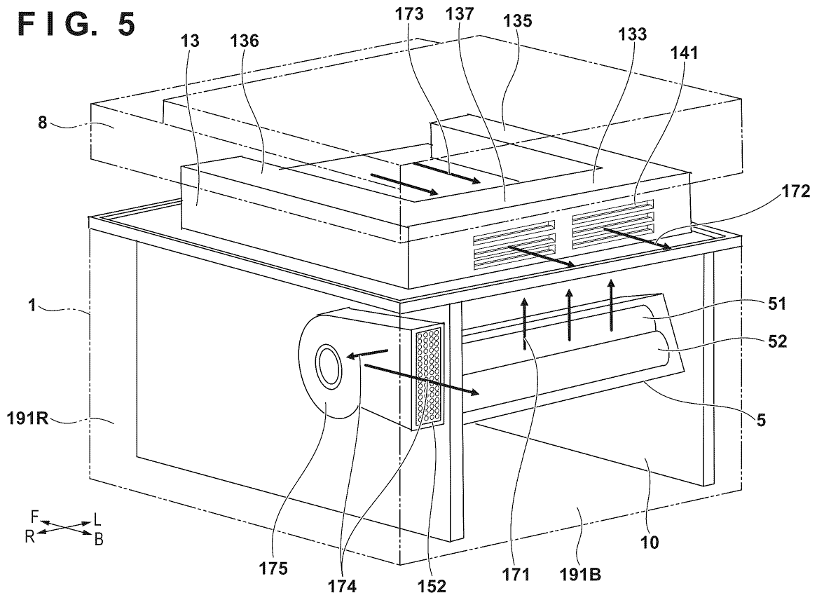

As shown in FIG. 1, the air duct opening 151 may be provided on the left side 191L and/or the right side 191R of the housing 10, respectively. As shown in FIG. 5, an electric fan 175 is provided on the right side 191R of the housing 10. The electric fan 175 intakes the air in the internal space of the main body unit 1 through the air duct opening 151, and exhausts the air to the outside of the image forming apparatus 100 along the airflow indicated by arrow 174. An exhaust opening 152 is provided on the back side 191B of the main body unit 1, the exhaust opening 152 discharges the air conveyed by the electric fan 175. As a result, heat is released to the outside of the image forming apparatus 100 together with the air.

Here, the electric fan 175 sucks air from inside the main body unit 1, as an example. The electric fan 175 may be a fan that introduces air external to the main body unit 1 into the main body unit 1. As a result, the inside of the main body unit 1 is cooled. Further, the air introduced into the main body unit 1 can push water vapor from the inside to the outside of the main body unit 1.

According to FIG. 5, it can be seen that the horizontal sectional shape of the coupling unit 13 is U shaped (⊐ shaped) . The coupling unit 13 is a support structure having a first support 135 and a second support 136 extending in parallel to the direction in which the recording medium S is discharged. Further, the coupling unit 13 includes a third support 137 extending perpendicularly to the direction in which the recording medium S is discharged. The third support 137 is a coupling unit in a narrow sense. The first support 135 and the second support 136 are coupled via the third support 137. Thus, the rigidity of the coupling unit 13 may be increased. The stacker unit 7 is disposed between the first support 135 and the second support 136.

Since the horizontal sectional shape of the coupling unit 13 is U shaped, the top, bottom, back, left, and right of the stacking space are closed, and only the front is opened. Therefore, water vapor released from recording mediums S stacked on the stacker unit 7 tends to be trapped in the stacking space. By the first embodiment, water vapor is efficiently released from the stacking space to the outside of the image forming apparatus 100 by the airflow indicated by arrows 173 and 172. That is, a water vapor releasing path is secured behind the stacking space. As indicated by arrow 171, the water vapor generated in the fixing unit 5 also merges with the water vapor from the stacking space and is discharged to the outside of the image forming apparatus 100.

### 12. Details of the Heat Dissipation Mechanism

Heat generated from the heating member 53 of the fixing unit 5 propagates to the recording medium S and the toner image, and also propagates to the fixing unit 5 itself and the internal space of the main body unit 1 as unnecessary heat. The heat generated in the fixing unit 5 heats air, and the heated air rises above the fixing unit 5. Above the fixing unit 5 is the coupling unit 13 integrated with the upper cover 18. The upper cover 18 supports the bottom surface 134 of the coupling unit 13. The bottom surface 134 of the coupling unit 13 comprises the opening 143. The coupling unit 13 connects with the inside of the main body unit 1 via the opening 143.

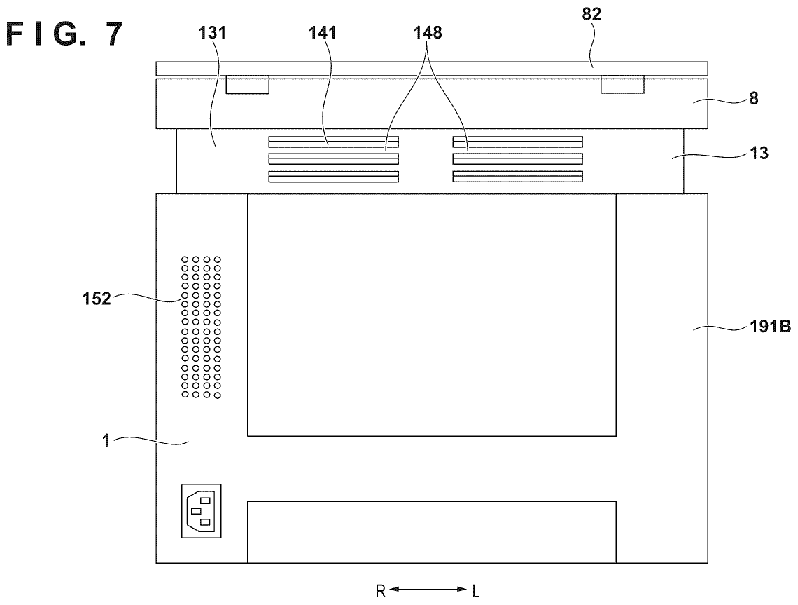

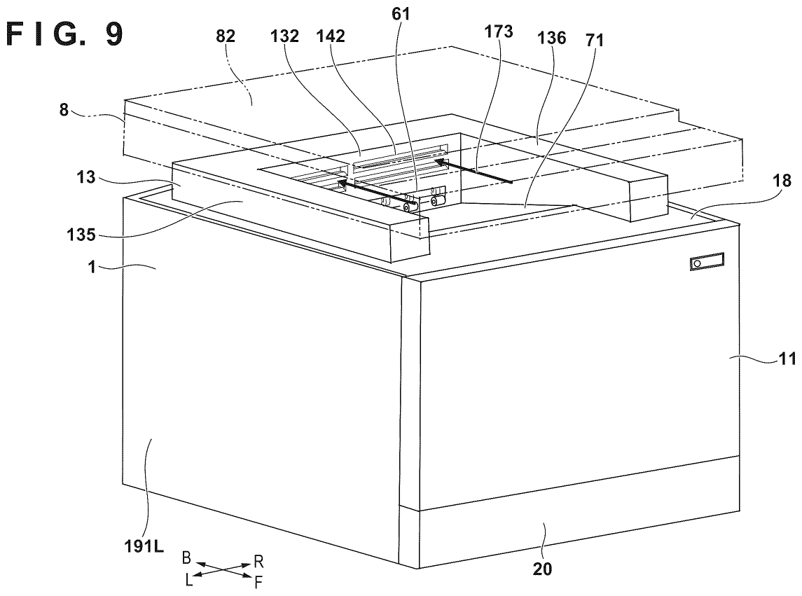

FIG. 6 is a front view illustrating the image forming apparatus 100. FIG. 7 is a back view illustrating the image forming apparatus 100. FIG. 8 is a perspective view illustrating the image forming apparatus 100. FIG. 9 is a perspective view in which a part of the image forming apparatus 100 is transparent. As shown in FIG. 6, the air duct opening 142 may include a louver 149. As shown in FIG. 7 and FIG. 8, the air duct opening 141 may include a louver 148. Each of the louvers 148 and 149 may have a plurality of slats to control the direction of air flow. Further, the louvers 148 and 149 having a plurality of slats disposed obliquely to direct the air discharge direction obliquely downward, to reduce entry of dust into the coupling unit 13.

As shown in FIG. 6 through FIG. 9, the coupling unit 13 comprises an outer wall 131 and an inner wall 132 facing each other as the two sides described above. The outer wall 131 and the inner wall 132 are coupled to the top surface 133. The outer wall 131 and the inner wall 132 may be referred to as vertical walls.

The outer wall 131 comprises the air duct opening 141 which serves as an exhaust opening or intake opening for connecting the outside and the inside of the main body unit 1. The air duct opening 141 is useful for releasing heat inside the main body unit 1 by natural convection. The inner wall 132 is a side wall facing the stacker unit 7 or the stacking space. The inner wall 132 comprises the air duct opening 142, which serves as an exhaust opening or intake opening. The air duct opening 142 allows the upper space (stacking space) of the stacking tray 71 to connect with the internal space of the coupling unit 13.

As shown in FIG. 1, the heat generated from the heating member 53 of the fixing unit 5 is applied to the recording medium S and simultaneously propagates to the air around the fixing unit 5. As indicated by arrow 171, the heated air rises above the fixing unit 5. The coupling unit 13 is above the fixing unit 5. Air enters the coupling unit 13 through the opening 143 of the coupling unit 13. As indicated by arrow 172, air is discharged to the outside of the image forming apparatus 100 through the air duct opening 141 provided in the outer wall 131.

As shown in FIG. 9, the air in the stacking space is attracted by natural convection indicated by arrow 173, and enters the coupling unit 13 through the air duct opening 142 provided in the inner wall 132. The air is also discharged from the air duct opening 141 provided on the back side 191B of the main body unit 1.

In this way, the heat generated by the fixing unit 5 propagates to the air, and the heated air starts to rise. The air moves from the main body unit 1 to the coupling unit 13, and is exhausted from the coupling unit 13 to the outside of the image forming apparatus 100 via the air duct opening 141. Generated heat also propagates to the air in the stacking space from the recording medium S, and this air enters the coupling unit 13 via the air duct opening 142, merges with the air from the main body unit 1, and is discharged to the outside from the air duct opening 141. That is, unnecessary heat is discharged efficiently to the outside of the image forming apparatus 100 by natural convection.

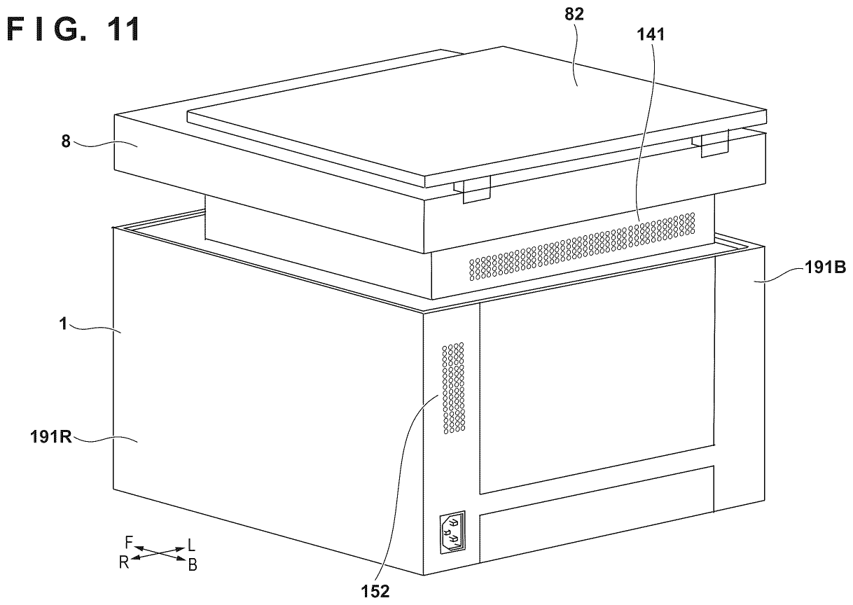

As shown in FIG. 11, the air duct opening 141 may have a plurality of through holes. Similarly, the air duct opening 142 may have a plurality of through holes. The shape of the through holes may be circular or rectangular.

Alternatively, the air duct opening 141 may be a single opening, and the air duct opening 142 may be a single opening. Note that one of the air duct openings 141 and 142 may have a plurality of through holes, and the other may have a single opening or an opening with a louver.

According to the first embodiment, heat dissipation performance can be improved with a simpler structure. The bottom surface 134 of the coupling unit 13 positioned above the fixing unit 5, which is a heat source, comprises the opening 143. Further, the coupling unit 13 comprises a U shape in a plan view. Since the coupling unit 13 comprises the opening 143, the inside of the main body unit 1 can be cooled by natural convection while maintaining the rigidity of the coupling unit 13. The heated air residing between the main body unit 1 and the reader unit 8 can also be discharged with a simple structure. The reader unit 8 and the coupling unit 13 are integrated with the upper cover 18. By opening the upper cover 18, consumables can be easily replaced. By opening the upper cover 18, a recording medium S that has become jammed inside the main body unit 1 may be removed.

In FIG. 1, the air duct opening 141 serves as a discharge opening (exhaust opening) for discharging air, and the air duct opening 142 serves as an input opening (intake opening) for intake of air. However, this is only an example. The air duct opening 141 may serve as an intake opening. The air duct opening 142 may serve as an exhaust opening. The roles of the air duct openings 141 and 142 (the intake opening/exhaust openings) may not be fixed, but rather change depending on the natural convection of the air. For example, at a certain timing, the air duct opening 142 may serve as a discharge opening for discharging the air heated by the fixing unit 5, and at another timing, the air duct opening 142 may serve as an intake opening.

In FIG. 1, the outer wall 131 and the inner wall 132 face each other, but this is merely an example. The outer wall 131 and the inner wall 132 may not face each other. For example, the outer wall 131 may be an outer wall of at least one of the first support 135 and the second support 136. The inner wall 132 may be an inner wall of at least one of the first support 135 and the second support 136. In this case, the outer wall 131 and the inner wall 132 would be orthogonal. Alternatively, the outer wall 131 may be provided on one of the first support 135 and the second support 136, and the inner wall 132 may be provided on one of the first support 135 and the second support 136.

The air duct opening 151 is provided with the electric fan 175, but this is merely an example. A plurality of air duct openings 151 may be provided in the main body unit 1. The air duct opening 151 may serve as an intake opening for taking in air from the outside of the main body unit 1 into the internal space of the main body unit 1. The air duct opening 151 may serve as an exhaust opening for discharging air from the internal space of the main body unit 1 to the outside of the main body unit 1.

### Second Embodiment

In the second embodiment, air heated by the main body unit 1 and air heated by the stacker unit 7 are discharged from an air duct opening provided in the reader unit 8. In the second embodiment, descriptions of the matters described in the first embodiment are incorporated by reference, for conciseness.

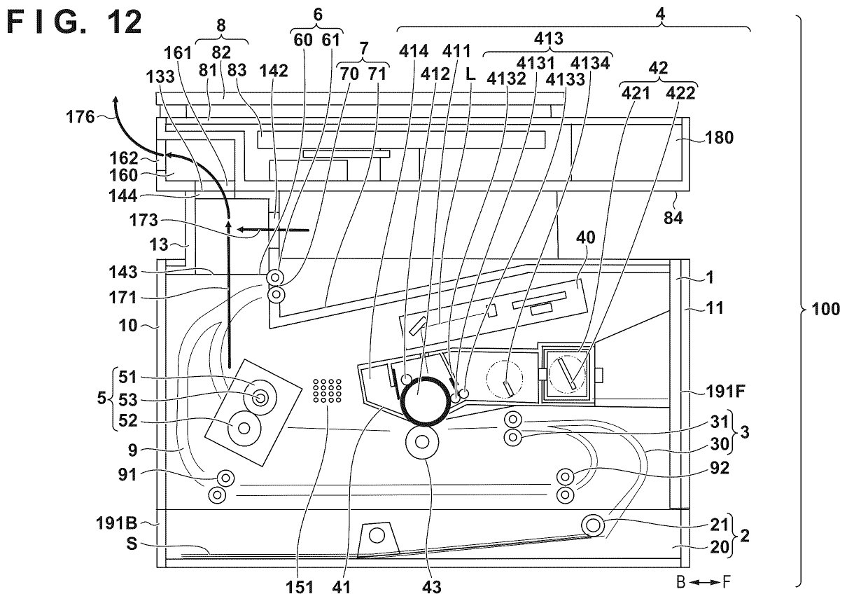

FIG. 12 is a simplified cross-sectional view of the image forming apparatus 100 of the second embodiment. The top surface 133 of the coupling unit 13 comprises an opening 144. The reader unit 8 includes a first chamber 180 that accommodates the image sensor 83 and the like, and a second chamber 160 that is isolated from the first chamber 180. The second chamber 160 is positioned above the coupling unit 13. The bottom surface of the second chamber 160 comprises an opening 161. The position, size, and shape of the opening 161 of the second chamber 160 and the opening 144 of the coupling unit 13 are determined so that the air in the internal space of the coupling unit 13 easily flows into the second chamber 160. In this manner, the coupling unit 13 and the second chamber 160 are connected through the opening 144 and the opening 161.

The air flowing into the coupling unit 13 from the main body unit 1 or the stacker unit 7 merges at the coupling unit 13 and flows into the second chamber 160. The direction of travel of the air changes from upward to rearward in the second chamber 160. As indicated by arrow 176, air is discharged from the second chamber 160 to the outside through an air duct opening 162.

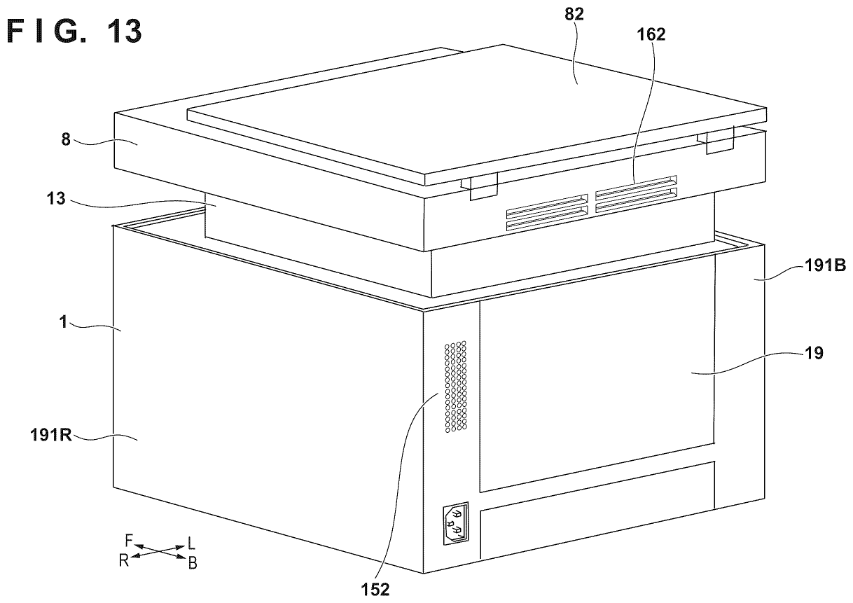

As shown in FIG. 13, the air duct opening 162 may have a louver. However, this is only an example. As described above, the air duct opening 162 may be a single opening or may have a plurality of through holes.

According to the second embodiment, the air duct opening 162 is provided in the reader unit 8 instead of the air duct opening 141. Thus, heat dissipation performance can be improved with a simpler structure. Further, the rigidity of the coupling unit 13 is maintained. The natural convection suppresses an increase in temperature inside the main body unit 1. Further, hot air residing in the stacking space between the main body unit 1 and the reader unit 8 can also be discharged with a simple structure.

### Third Embodiment

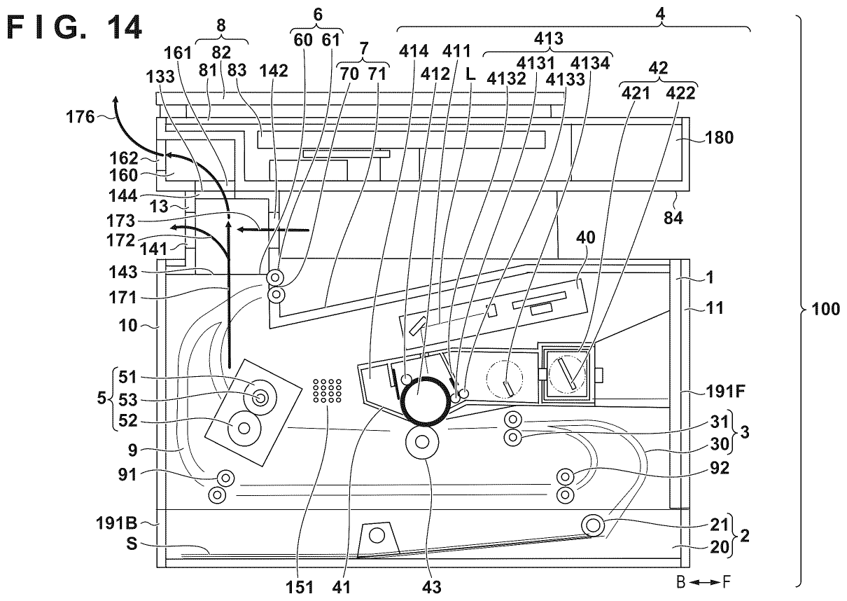

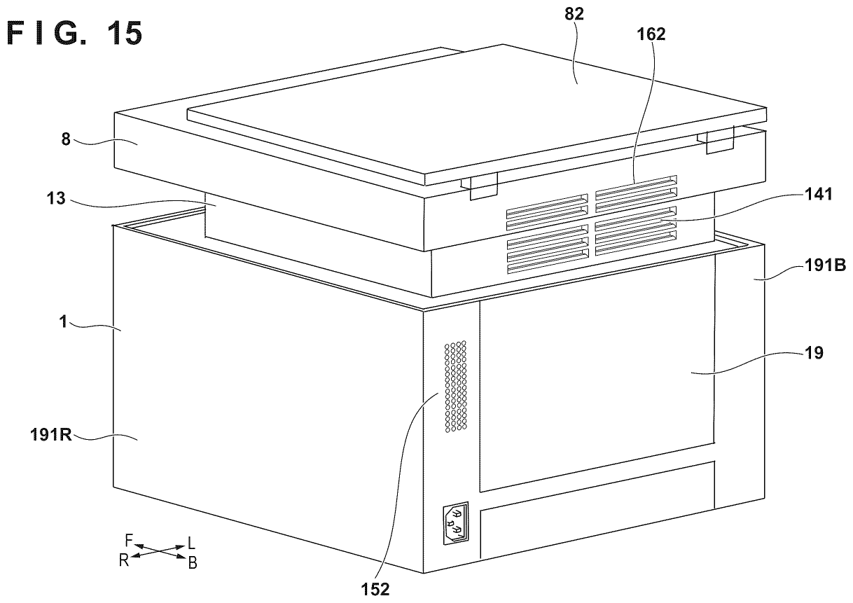

The third embodiment is a combination of the first embodiment and the second embodiment. As shown in FIG. 14 and FIG. 15, the second chamber 160 is connected with the coupling unit 13 through the openings 161 and 144, and the second chamber 160 comprises the air duct opening 162. Further, the coupling unit 13 comprises the air duct opening 141 described in detail in the first embodiment.

Since the air duct opening 162 is provided in addition to the air duct opening 141 as described above, the heated air from the main body unit 1 and the heated air from the stacker unit 7 can be efficiently discharged to the outside of the image forming apparatus 100 with a simple structure. Thus, in the third embodiment, heat dissipation performance can be improved with a simple structure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-130008 filed Aug. 6, 2024 which is hereby incorporated by reference herein in its entirety.

What is claimed is:

1. An image forming apparatus comprising:
a main body unit having an image forming unit configured to form an image on a recording medium;
a reader unit disposed above the main body unit and configured to read a document;
a stacker unit disposed between the main body unit and the reader unit, wherein the recording medium, on which an image has been formed by the main body unit, is stacked on the stacker unit; and
a coupling unit configured to couple the main body unit and the reader unit, and support the reader unit,
wherein the coupling unit comprises:
a top surface that supports the reader unit,
a bottom surface supported by the main body unit,
a first wall that extends from the bottom surface toward the top surface,
a second wall that extends from the bottom surface toward the top surface; and
a first opening provided on the bottom surface and that connects an internal space between the first wall and the second wall, and the main body unit,
wherein the first wall comprises a first air duct opening that connects the internal space and an external space, and
the second wall comprises a second air duct opening that connects the internal space and the external space.

2. The image forming apparatus according to claim 1, wherein the first air duct opening is configured as a discharge opening for discharging air that passes through the first opening from the main body unit and rises into the internal space of the coupling unit and air that enters the internal space of the coupling unit from the second air duct opening.

3. The image forming apparatus according to claim 1, wherein the first wall and the second wall face each other.

4. The image forming apparatus according to claim 3, wherein the second air duct opening is configured as an intake opening that connects with a stacking space formed between the stacker unit, which is provided above the main body unit, and a bottom surface of the reader unit, and intakes air from the stacking space warmed by heat released from the recording medium, which has been stacked on the stacker unit, into the internal space of the coupling unit, and
the first air duct opening is configured as a discharge opening that discharges the air taken into the internal space from the stacking space.

5. The image forming apparatus according to claim 1, wherein the second air duct opening is configured as a discharge opening for discharging air that passes through the first opening from the main body unit and rises into the internal space of the coupling unit.

6. The image forming apparatus according to claim 1, wherein the reader unit comprises:
a first chamber in which an image sensor for reading the document is present, and
a second chamber that connects with the internal space of the coupling unit, and wherein:
the second chamber comprises a third air duct opening that exhausts air that has risen from the coupling unit into the second chamber outside of the reader unit.

7. The image forming apparatus according to claim 6, wherein:
the second air duct opening is configured as an intake opening that connects with a stacking space formed between the stacker unit, which is provided above the main body unit and a bottom surface of the reader unit, to transfer air from the stacking space warmed by heat released from the recording medium, which has been stacked on the stacker unit, into the internal space of the coupling unit, and
the third air duct opening is configured as a discharge opening that discharges the air taken into the internal space of the coupling unit from the stacking space to outside.

8. The image forming apparatus according to claim 1, wherein the coupling unit is provided above the main body unit and is a part of a structure supporting the reader unit, the structure having a U shaped horizontal sectional shape.

9. The image forming apparatus according to claim 8, wherein the structure comprises a first support and a second support each extending in a direction parallel to discharge of the recording medium, and a third support coupling the first support and the second support, the third support extending perpendicular to the direction in which the first support and a second support each extend, and wherein:
the stacker unit is disposed between the first support and the second support, and
the coupling unit includes the third support.

10. The image forming apparatus according to claim 1, further comprising at least one louver provided in at least one of the first air duct opening and the second air duct opening.

11. The image forming apparatus according to claim 1, wherein a plurality of through holes are provided in at least one of the first air duct opening and the second air duct opening.

12. The image forming apparatus according to claim 11, wherein the plurality of through holes are shaped as one of circles and/or rectangles.

13. The image forming apparatus according to claim 1, wherein the main body unit comprises another air duct opening configured for one of entry of air into an internal space of the main body unit from outside of the main body unit and discharge of air from the internal space to the outside of the main body unit.

14. The image forming apparatus according to claim 13, further comprising a fan provided on the another air duct opening.

15. The image forming apparatus according to claim 1, further comprising:
a discharge unit configured to discharge the recording medium to the stacker unit; and
a cover unit in which the discharge unit, the coupling unit, and the reader unit are formed integrally; and
a hinge that pivotably supports the cover unit with respect to the main body unit.

16. The image forming apparatus according to claim 15, wherein the stacker unit is integrated into the cover unit.

17. The image forming apparatus according to claim 15, wherein the main body unit comprises a processing unit, which is configured to develop an electrostatic latent image with toner, form a toner image, and transfer the toner image to the recording medium, and
wherein the processing unit is attachable to and removable from the main body unit based on the cover unit moving between a closed state and an open state.

18. The image forming apparatus according to claim 17, wherein:
the processing unit includes a plurality of separatable assemblies,
the main body unit comprises a back side, a front side, a right side, and a left side, and
the front side has an opening for attaching or removing at least one of the plurality of assemblies.

19. The image forming apparatus according to claim 1, wherein the main body unit comprises a fixing mechanism configured to fix a toner image transferred to the recording medium onto the recording medium, and
wherein the coupling unit is positioned above the fixing mechanism.

20. An image forming apparatus comprising:
a main body unit comprising an image forming unit configured to form an image on a recording medium;
a reader unit disposed above the main body unit and configured to read a document;
a stacker unit disposed between the main body unit and the reader unit, wherein the recording medium, on which an image has been formed by the main body unit, is stacked on the stacker unit; and
a coupling unit configured to couple the main body unit and the reader unit, and support the reader unit,
wherein the coupling unit comprises:
a top surface that supports the reader unit,
a bottom surface supported by the main body unit,
a first wall that extends from the bottom surface toward the top surface,
a second wall that extends from the bottom surface toward the top surface and that faces the stacker unit, and
a first opening provided on the bottom surface and that connects an internal space between the first wall and the second wall, and the main body unit,
wherein the reader unit comprises:
a first chamber in which an image sensor for reading the document is present, and
a second chamber that connects with the internal space of the coupling unit,
wherein the second wall comprises a first air duct opening that connects an internal space of the coupling unit and an external space, and
wherein the second chamber comprises a second air duct opening that exhausts air that has risen from the coupling unit into the second chamber to outside of the reader unit.

21. The image forming apparatus according to claim 20, wherein the first air duct opening is configured as a discharge opening for discharging air that passes through the first opening from the main body unit and rises into the internal space of the coupling unit and for discharging air that enters the internal space of the coupling unit from the second air duct opening.

22. The image forming apparatus according to claim 20, wherein:
the first air duct opening is configured as an intake opening that connects with a stacking space formed between the stacker unit, which is provided above the main body unit and a bottom surface of the reader unit, to transfer air from the stacking space warmed by heat released from the recording medium, which has been stacked on the stacker unit, into the internal space of the coupling unit, and
the second air duct opening is configured as a discharge opening that discharges the air taken into the internal space from the stacking space to the outside.
